(19) United States
(12) Patent Application Publication
(10) Pub. No.: US 2019/0359913 A1
(43) Pub. Date: Nov. 28, 2019

(54) FUNCTIONALIZED SILOXANE POLYMERS WITH CLEAVABLE PENDANT GROUP

(71) Applicant: The Procter & Gamble Company, Cincinnati, OH (US)

(72) Inventors: Rajan Keshav PANANDIKER, West Chester, OH (US); Bernard William KLUESENER, Harrison, OH (US)

(21) Appl. No.: 16/413,654

(22) Filed: May 16, 2019

Related U.S. Application Data
(60) Provisional application No. 62/675,198, filed on May 23, 2018.

(51) Int. Cl. C11D 3/37; C08G 77/12; C08G 77/18; C08G 77/38; C08G 77/388; C11D 11/00; C11D 3/33; C11D 3/50

(52) U.S. Cl. CPC C11D 3/3742; C08G 77/12; C08G 77/18; C08G 77/38; C11D 3/502; C11D 11/0017; C11D 3/3738; C11D 3/3773; C11D 3/33; C08G 77/388

(57) ABSTRACT

Functionalized siloxane polymers that include a cleavable pendant group, such as one that includes an ester bond. Compositions, for example consumer product compositions, that include such silicones. Methods of making and using such polymers and compositions.

### FIELD OF THE INVENTION

The present disclosure relates to functionalized siloxane polymers that include a cleavable pendant group. The present disclosure also relates to compositions, for example consumer product compositions, that include such silicones. The present disclosure also relates to methods of making and using such polymers and compositions.

### BACKGROUND OF THE INVENTION

Functionalized siloxane polymers can provide numerous treatment benefits to various types of surfaces, including fabric softness, hair conditioning, fabric anti-wrinkle control, shape maintenance, stain control, and color care.

Furthermore, sustainable and/or environmentally friendly materials are currently highly desired as they typically require less energy to make, lower levels of raw materials, and/or are easier to dispose of.

There is a need for polymers and compositions that can provide treatment benefits while having an improved sustainability/environmental/degradability profile.

### SUMMARY OF THE INVENTION

The present disclosure relates to siloxane polymers that include a pendant group. The siloxane polymers may include one or more repeat units having a structure/empirical formula according to Formula I:

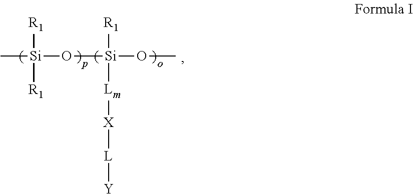

where the X moiety is a moiety that includes a cleavable bond; the R₁, L, X, and Y moieties are described in more detail below.

The present disclosure further relates to compositions, such as consumer product compositions, that includes such siloxane polymer. The compositions may further comprise a carrier.

The present disclosure further relates to methods of treating a surface with such compositions.

### BRIEF DESCRIPTION OF THE DRAWINGS

The figures herein are illustrative in nature and are not intended to be limiting.

FIG. 1 shows a table that includes the structures of the polymers formed in the Synthesis Examples.

### DETAILED DESCRIPTION OF THE INVENTION

The present disclosure relates to functionalized siloxane polymers that include a pendant group. The pendant group includes a moiety that includes a bond that is readily cleavable, such as an ester group. The pendant group may also contain the functional moiety.

Without wishing to be bound by theory, it is believed that the functionalized siloxane polymers of the present disclosure are stable under typical storage and/or product composition conditions (for example, in a liquid fabric enhancer at a pH of from about 2-4). However, after being used as intended, the polymers will tend to hydrolyze at the moiety that includes the cleavable bond, resulting in improved biodegradability. For example, when the pendant group contains an amino or quaternary ammonium moiety, the cleavable bond may hydrolyze (for example, at approximately pH 7, under waste water conditions, and/or when exposed to enzymes such as esterases in the environment) and effectively release the functional moiety from the siloxane backbone.

The siloxane polymers, compositions, and methods of the present disclosure are described in more detail below.

### Definitions

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein “consumer product” means baby care, beauty care, fabric & home care, family care, feminine care, health care products or devices intended to be used or consumed in the form in which it is sold, and not intended for subsequent commercial manufacture or modification. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use; and shaving products, products for and/or methods relating to treating fabrics, hard surfaces and any other surfaces in the area of fabric and home care, including: air care, car care, dishwashing, fabric conditioning (including softening), laundry detergency, laundry and rinse additive and/or care, hard surface cleaning and/or treatment, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening.

As used herein, the term “cleaning and/or treatment composition” includes, unless otherwise indicated, granular or powder-form all-purpose or “heavy-duty” washing agents, especially cleaning detergents; solid, granular or powder or beads-form fabric freshening or fabric care compositions; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners; hair shampoos and hair-rinses; shower gels and foam baths and metal cleaners; fabric care composition; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Siloxane Polymer

The present disclosure relates to siloxane polymers, particularly functionalized siloxane polymers that have a pendant group. The pendant group may include a moiety (e.g., described below as the “X” moiety) that includes a cleavable bond, such as an ester bond. It is believe that the presence of the cleavable bond facilitates degradation of the polymer.

It is understood that the cleavable bond may be located on a pendant of the siloxane polymer in such a position so that only a portion of the pendant is removeable from siloxane backbone. For example, post-hydrolysis, one or more linker groups (or at least the moieties that served as linker groups, pre-hydrolysis) or a portion thereof may remain in a pendant-like orientation.

The siloxane polymer may comprise one or more repeat units having the structure of (and/or empirical formula according to) Formula (I):
wherein:

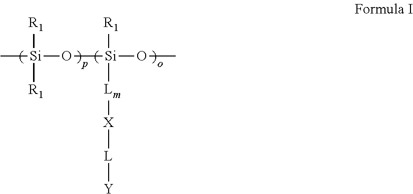

a) each L is a linking bivalent alkylene radical, preferably each L is independently selected from the group consisting of

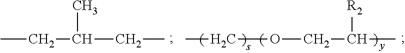

—(CH₂)ₛ—; —((H₂C)ₛOC₆H₄— and combinations thereof, more preferably at least one L is —(CH₂)ₛ— or —(H₂C)ₛOC₆H₄—, even more preferably at least one L is —(CH₂)ₛ—,
wherein
each R₂ is independently selected from the group consisting of H, C₁-C₄ alkyl, substituted alkyl, aryl, substituted aryl, and combinations thereof, preferably H or C₁-C₄ alkyl, most preferably H or methyl,
each s is independently an integer of from 1 to about 20, preferably each s is independently an integer of from 2 to about 12;
each y is independently an integer of from 1 to about 100, preferably each y is independently an integer of from 1 to about 20, more preferably y is independently an integer of from 1 to about 10;
b) each X is independently selected from the group consisting of a Group I (non-ester) moiety or a Group II (ester) moiety, wherein Groups I and II are defined as follows:
   (i) a Group I (non-ester) moiety is selected from the group consisting of:

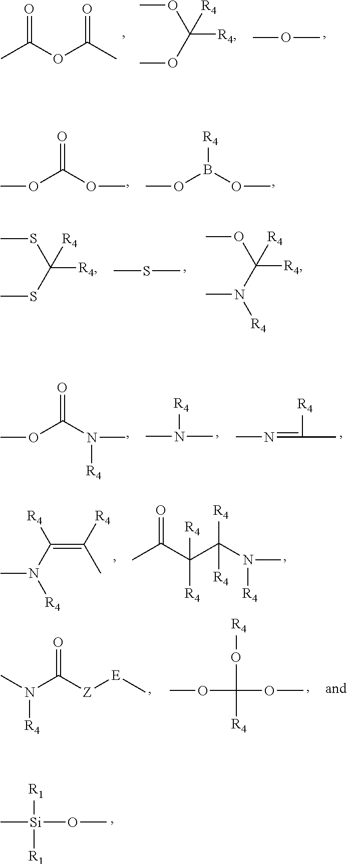

wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; wherein Z is defined as below;
preferably each X is independently selected from the group consisting of

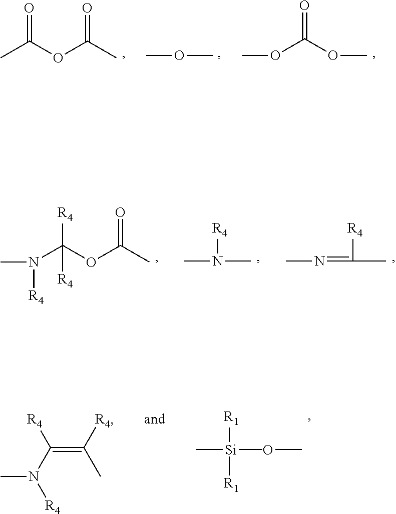

more preferably each X is independently selected from the group consisting of

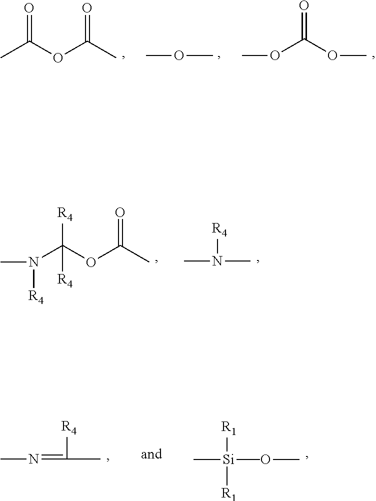

wherein each index m is one or zero with the proviso that when X is oxygen, the index m is 0;
(ii) a Group II (ester) moiety is selected from the group consisting of:

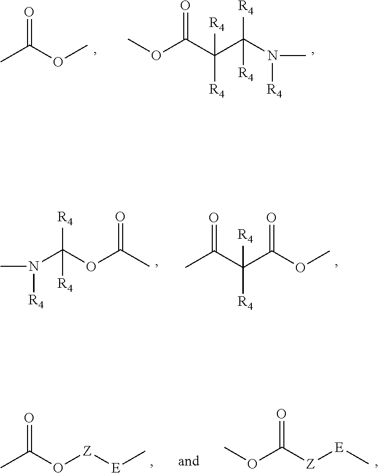

wherein E is an electron-withdrawing group, preferably E is selected from the group consisting of N, O, S, an aryl moiety, and an alkene moiety, more preferably E is N;
each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; and
each Z may be independently selected from the group consisting of C₁-C₃₂ alkylene, C₁-C₃₂ substituted alkylene, C₆-C₃₂ aryl, C₅-C₃₂ substituted aryl, C₆-C₃₂ alkylenearyl, and C₅-C₃₂ substituted alkylenearyl, preferably Z is C₁-C₃₂ alkylene or C₁-C₃₂ substituted alkylene, most preferably Z is selected from C₁-C₄ alkylene or C₁-C₄ substituted alkylene;
additionally or alternatively, each Z may be independently selected from the group consisting of:

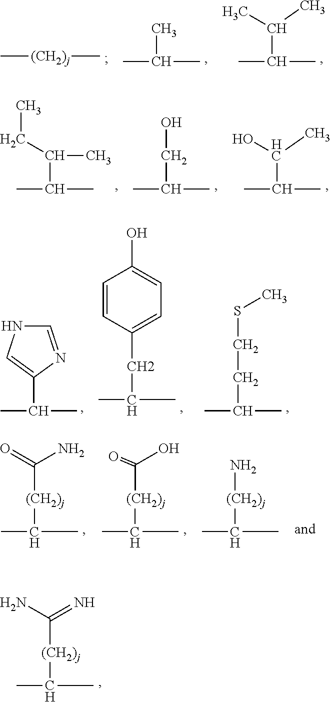

the index j is an integer from 1-32, preferably j is an integer form 1-10, more preferably j is an integer from 2 to 8, most preferably j in an integer from 2 to 4,
wherein each index m is one;
c) each R₁ is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy; preferably each R₁ is independently selected from the group consisting of H, OH, C₁-C₁₆ alkyl, C₁-C₄ alkoxy, a benzyl moiety and a phenylpropyl moiety, more preferably each R₁ is independently selected from the group consisting of H, OH, C₁ alkyl and C₁ alkoxy;
d) each Y is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl and C₆-C₃₂ substituted alkylaryl, preferably Y contains an amino moiety, a hydroxy moiety, a thiol moiety, a carboxy moiety and a quaternary ammonium moiety, more preferably Y contains an amino moiety or a quaternary ammonium moiety.
e) index p is an integer of from about 2 to about 1000, preferably p is an integer from about 10 to about 500, more preferably p is an integer from about 20 to about 200; and
f) index o is an integer of from about 1 to about 500, preferably o is an integer from about 1 to about 50, more preferably o is an integer from about 1 to about 20.

For clarity, the “-Lₘ-X-L-Y” portion of the repeat unit is the pendant portion of the siloxane polymer. It is also understood that the siloxane polymers of the present disclosure may have a structure where the repeat units are present in random or blocky orientations, preferably random.

The pendant portion of the siloxane polymer may have more than one cleavable bond. For example, the pendant portion may include more than one X moiety. The pendant portion may have the general formula

-Lₘ-X₁—(R₃—X₂)_{q}-L-Y

where the L moieties, the Y moiety and the m index are as defined herein; where the X₁ and X₂ are independently selected from X moieties described herein, e.g., Group I (non-ester) moieties and/or Group II (ester) moieties; where the index q is 1 or zero, preferably 1 if the pendant is to have more than one cleavable bond; and where each R₃ is independently selected from the group consisting of C₁-C₃₂ alkylene, C₁-C₃₂ substituted alkylene, C₆-C₃₂ aryl, C₅-C₃₂ substituted aryl, C₆-C₃₂ alkylenearyl, and C₅-C₃₂ substituted alkylenearyl, when R₃ moiety comprises two or more carbon atoms said R₃ moiety may optionally but preferentially be interrupted by a hetero atom selected from the group consisting of N, O and S and combinations thereof; preferably the R3 moiety is interrupted by N, more preferably R3 is a C4-C12 alkylene interrupted by N.

The siloxane polymers according to the present disclosure may have the following general structure/empirical formula:

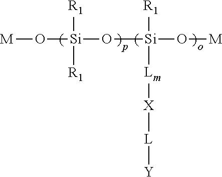

wherein:
   a) each L is a linking bivalent alkylene radical, preferably L is selected from —(CH₂)ₛ— and

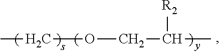

more preferably L is —(CH₂)ₛ—,
each s is independently an integer of from 1 to about 20, preferably each s is independently an integer of from 2 to about 12;
b) each X is independently selected from the group consisting of:
   (i) a Group I (non-ester) moiety:

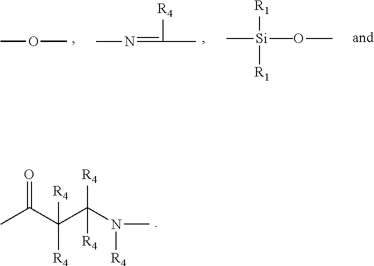

wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl,
wherein each index m is one or zero with the proviso that when X is oxygen, the index m is 0; and/or
(ii) a Group II (ester) moiety:

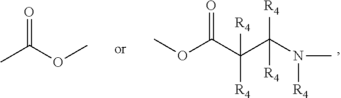

wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl,
wherein each index m is one;
c) each R₁ is methyl;
d) each Y is independently selected from the group consisting of C₁-C₃₂ substituted alkyl, C₅-C₃₂ substituted aryl, C₆-C₃₂ substituted alkylaryl, wherein the substitution, if any, is an amino moiety or quaternary ammonium moiety;
e) index p is an integer of from about 10 to about 500;
f) index o is an integer of from about 1 to about 20; and
g) each M is

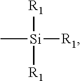

wherein each R₁ is independently selected from the group as is described above.

In the siloxane polymers according to the above structures, each X may be independently selected from one of the following Group I (non-ester) moieties:

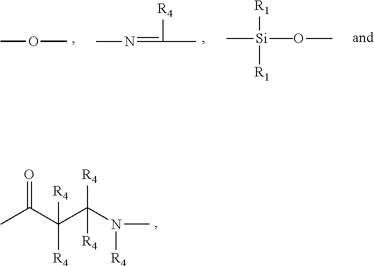

wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl.

It may be preferred that X is a Group II (ester) moiety, as the ester-based bonds are readily cleavable. In the siloxane polymers according to the above structures, each X may be independently selected from one of the following Group II (ester) moieties:

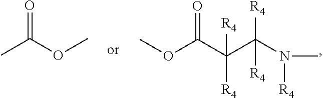

wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl. It is believed that siloxane polymers having X selected from the above group biodegrade relatively easily.

In the siloxane polymers according to the above structures, each X may be

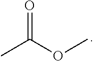

In the siloxane polymers according to the above structures, the Y group may comprise an amino moiety or quaternary ammonium moiety. It is believed that such moieties improve the performance of siloxane polymers in many consumer products.

Exemplary synthesis processes to make polymers according to the present disclosure are provided below as Synthesis Examples.

### Compositions

The present disclosure relates to compositions that include the above-described siloxane polymers. The compositions may comprise from about 0.2% to about 10%, preferably from about 0.5% to about 5%, by weight of said composition, of the siloxane polymer. The composition may include a siloxane polymer and a carrier. The compositions of the present disclosure may include a siloxane polymer according to any of Synthesis Examples 1-13, as provided below, preferably any of Synthesis Examples 7-13.

The composition may be a consumer product. The composition may be a cleaning and/or treatment composition. The composition may be a fabric care composition. The composition may be a fabric softening composition, a fabric enhancing composition, a fabric freshening composition, or a combination thereof, preferably in liquid form.

The composition may have any suitable form. The composition may have a form selected from liquid, powder, single-phase or multi-phase unit dose article or pouch (which may have one or more compartments), film, woven web, non-woven web, dissolvable bead or pastille, gel, paste, bar, or flake. The composition may be a liquid composition, such as a liquid fabric enhancer, or a solid composition, such as a laundry powder or dissolvable pastille. The cleaning composition may be in the form of a unit dose article, which may contain liquid, gel, paste, powder, pastilles, or mixtures thereof, encapsulated in a water-soluble film. The siloxane polymer may be part of a coating, for example on a granule, pastille, tablet, or exterior surface of a pouch. The composition may be in solid form, such as in the form of a dissolvable bead or pastille, which may include: from about 60% to about 98% by weight of the composition of polyethylene glycol having a molecular weight from 5,000 to 11,000 Da; from about 0.1% to about 10% by weight of a siloxane polymer according to the present disclosure; from about 2% to about 12% by weight of the composition of free perfume; and optionally from about 2% to about 12% by weight thereof of perfume microcapsules comprising encapsulated perfume.

When the composition is a liquid or gel composition, the composition may have any pH in which the siloxane polymer is sufficiently stable (e.g., minimal hydrolysis). For example, the composition may have a neat pH of from about 2 to about 4, preferably a pH of from about 2 to about 3.7, more preferably a pH from about 2 to about 3.5, preferably in the form of an aqueous liquid. It is believed that such pH levels facilitate stability of the siloxane polymer.

The composition may include a carrier. Suitable carriers may include be liquid carriers or solid carriers. Suitable carriers may include water, non-aqueous solvents, a salt, or a combination thereof.

Non-aqueous solvents may include organic solvents, such as methanol, ethanol, propanol, isopropanol, 1,3-propanediol, 1,2-propanediol, ethylene glycol, glycerine, glycol ethers, hydrocarbons, or mixtures thereof. Other non-aqueous solvents may include lipophilic fluids such as siloxanes or other silicones, hydrocarbons, perfluorinated amines, perfluorinated and hydrofluoroether solvents, or mixtures thereof. Amine-containing solvents, such as monoethanolamine, diethanolamine and triethanolamine, may also be used.

The carrier may be a water-soluble carrier. Such carriers may include water-soluble inorganic alkali metal salt, water-soluble alkaline earth metal salt, water-soluble organic alkali metal salt, water-soluble organic alkaline earth metal salt, water soluble carbohydrate, water-soluble silicate, water-soluble urea, and any combination thereof. Polyalkylene glycols, such as polyethylene glycols, may be suitable carriers.

The compositions of the present disclosure may include additional adjunct ingredients. The adjunct ingredients and levels thereof may be selected according to the desired form and intended treatment benefit(s). For example, the composition may include an adjunct selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume (e.g., neat and/or encapsulated), an additional perfume delivery system, structure elasticizing agents, thickeners/structurants, fabric softeners, carriers, hydrotropes, oligoamines, processing aids, hueing agents, pigments and mixtures thereof.

The composition may include a surfactant, preferably wherein said surfactant is selected from the group consisting of an anionic surfactant, a nonionic surfactant, a cationic surfactant, an amphoteric surfactant, and mixtures thereof, more preferably said surfactant is selected from the group consisting of a linear or branched alkyl benzene sulfonate, an alkyl sulfate, an alkyl ethoxy sulfate, an alkyl ethoxylate, an alkyl glyceryl sulfonate, a quaternary ammonium surfactant, and mixtures thereof, preferably wherein said quaternary ammonium surfactant is an ester quaternary ammonium compound, which may act as a fabric softening active.

The composition may include a fabric softening active (“FSA”). Suitable fabric softening actives may include ester quaternary ammonium compounds, non-ester quaternary ammonium compounds, amines, fatty esters, sucrose esters, silicones (other than the siloxane polymers described above), dispersible polyolefins, polysaccharides, fatty acids, softening oils, polymer latexes, or combinations thereof. The present compositions may preferably include ester quaternary ammonium compounds.

The composition may include, based on total composition weight, from about 3% to about 25%, preferably from about 4% to about 20%, more preferably from about 5% to about 15%, most preferably from about 7% to about 12%, of an ester quaternary ammonium compound, particularly when the composition is a liquid, such as a liquid fabric enhancer or softener composition. The composition of the present invention may further comprise from 0.01% to 10%, preferably from 0.1% to 10%, more preferably from 0.1% to 5% of additional fabric softening active. The level of ester quaternary ammonium compound may depend of the desired concentration of total softening active in the composition (diluted or concentrated composition) and of the presence or not of other softening active.

As used herein, the term ester quaternary ammonium compound is synonymous with quaternary ammonium ester softening active. Suitable quaternary ammonium ester softening actives include but are not limited to materials selected from the group consisting of monoester quats, diester quats, triester quats, and mixtures thereof. Preferably, the level of monoester quat is from 2.0% to 40.0%, the level of diester quat is from 40.0% to 98.0%, and/or the level of triester quat is from 0.0% to 25.0% by weight of total quaternary ammonium ester softening active. Preferably the iodine value of the parent fatty acid from which the quaternary ammonium fabric softening active is formed is from 0 to 100, preferably from 10 to 60, more preferably 15 to 45.

The quaternary ammonium ester softening active may include compounds of the following formula:

{R²₍₄₋ₘ₎—N+—[X—Y—R¹]ₘ} A-

wherein: m is 1, 2 or 3 with proviso that the value of each m is identical; each R¹ is independently hydrocarbyl, or branched hydrocarbyl group, preferably R¹ is linear, more preferably R¹ is partially unsaturated linear alkyl chain; each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl; each X is independently (CH₂)n, CH₂—CH(CH₃)— or CH—(CH₃)—CH₂— and each n is independently 1, 2, 3 or 4, preferably each n is 2; each Y is independently —O—(O)C— or —C(O)—O—; A- is independently selected from the group consisting of chloride, methylsulfate, and ethylsulfate, preferably A- is selected from the group consisting of chloride and methylsulfate; with the proviso that when Y is —O—(O)C—, the sum of carbons in each R¹ is from 13 to 21, preferably from 13 to 19.

Examples of suitable quaternary ammonium ester softening actives are commercially available from KAO Chemicals under the trade name Tetranyl AT-1 and Tetranyl AT-7590; from Evonik under the tradename Rewoquat WE16 DPG, Rewoquat WE18, Rewoquat WE20, Rewoquat WE28, and Rewoquat 38 DPG; and from Stepan under the tradename Stepantex GA90, Stepantex VR90, Stepantex VK90, Stepantex VA90, Stepantex DC90, and Stepantex VL90A.

The composition may include perfume. The perfume may be neat perfume, encapsulated perfume, or a mixture thereof. The composition may further include a perfume delivery system. The encapsulated perfume may be formed by at least partially surrounding a perfume with a wall material. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol and mixtures thereof. The melamine wall material may comprise melamine crosslinked with formaldehyde, melamine-dimethoxyethanol crosslinked with formaldehyde, and mixtures thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The perfume capsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, and combinations thereof. One or more types of microcapsules, for examples two microcapsules types, wherein one of the first or second microcapsules (a) has a wall made of a different wall material than the other; (b) has a wall that includes a different amount of wall material or monomer than the other; or (c) contains a different amount perfume oil ingredient than the other; or (d) contains a different perfume oil, may be used.

The perfume delivery technology may comprise an amine compound (ARP) or a thio compound. One may also use “reactive” polymeric amines and or polymeric thios in which the amine and/or thio functionality is pre-reacted with one or more perfume raw materials (PRMs) to form a compound. Typically, the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. A material that contains a heteroatom other than nitrogen and/or sulfur, for example oxygen, phosphorus or selenium, may be used as an alternative to amine compounds. A single molecule may comprise an amine moiety and one or more of the alternative heteroatom moieties, for example, thiols, phosphines and selenols. The benefit may include improved delivery of perfume as well as controlled perfume release.

The composition may include a deposition aid. The deposition aid may include a cationic polymer, preferably a cationic polymer having a net cationic charge density of from about 0.2 meq/g to about 20 meq/g.

Composition, such as consumer products, may be made according to conventional processes. For example, a composition, such as a consumer product, may be made by combining a siloxane polymer according to the present disclosure with a carrier, optionally also with adjunct ingredients. Such processes may be batch processes, continuous-loop processes, and/or in-line mixing processes.

### Methods

The present disclosure relates to methods of using the above-described polymers and compositions.

Compositions containing the silicone compound disclosed herein can be used to clean or treat a surface, such as a fabric. Typically, at least a portion of the surface is contacted with a siloxane polymer or composition of the present disclosure, in neat form or diluted in a liquor, for example, a wash liquor and then the surface may be optionally washed and/or rinsed. In one aspect, a surface is optionally washed and/or rinsed, contacted with a siloxane polymer or composition according to the present disclosure, and then optionally washed and/or rinsed. For purposes of the present invention, washing includes but is not limited to scrubbing and/or mechanical agitation. The fabric may comprise most any fabric capable of being laundered or treated in normal consumer use conditions.

For example, the present disclosure relates to a method of treating a surface, such as a fabric, where the method includes the step of contacting a surface with a siloxane polymer or composition as described herein, preferably a composition, more preferably a fabric treatment composition, even more preferably a liquid fabric enhancer. At least a portion of the contacting step may preferably occur in the presence of water, preferably in an automatic washing machine, more preferably during the rinse cycle of an automatic washing machine.

Treatment liquors that may comprise the disclosed compositions may have a pH of from about 3 to about 11.5, or even a pH of from about 5.0 to about 10. The treatment liquor may have a pH that is greater than the pH of the consumer product composition. For example, the consumer product composition may be a liquid composition, preferably a liquid fabric enhancer composition, having a pH of from about 2 to about 4, whereas a treatment liquor, which may be formed by diluting a consumer product composition according to the present disclosure with water, may have a pH of from about 5.0 to about 10. By keeping the pH of the consumer product composition relatively low, it is believed that the siloxane polymer has improved stability. By having the pH of the treatment liquor relatively higher, it is believed that the undeposited siloxane polymer that is carried away when the liquor is drained from the treatment vessel is more likely to hydrolyze at the cleavable bond in the pendant, thereby degrading into a more environmentally friendly form.

The disclosed compositions compositions are typically employed at concentrations of from about 500 ppm to about 15,000 ppm in solution. When the wash solvent is water, the water temperature typically ranges from about 5° C. to about 90° C. When the surface includes a fabric, the water to fabric weight ratio is typically from about 1:1 to about 30:1.

For example, the present disclosure relates to a method of treating a surface, where the method includes the step of contacting a surface with a siloxane polymer or composition as described herein. At least a portion of the contacting step may preferably occur in the presence of water, preferably in an automatic washing machine, more preferably during the rinse cycle of an automatic washing machine.

### EXAMPLES

The examples provided below are intended to be illustrative in nature and are not intended to be limiting.

### Synthesis Examples

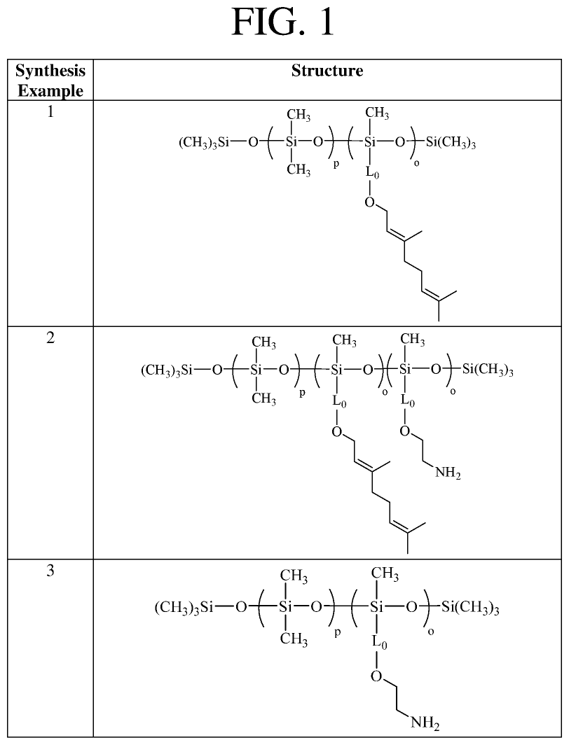

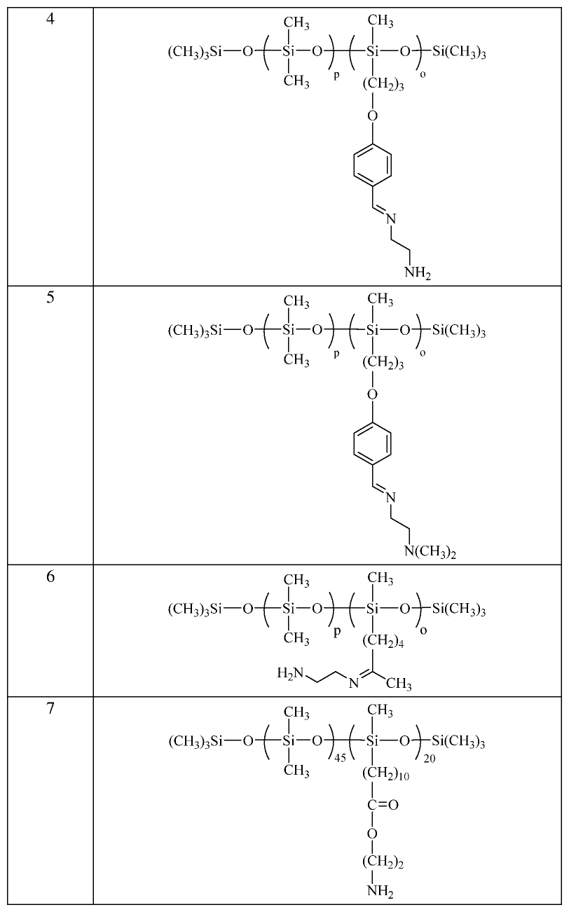

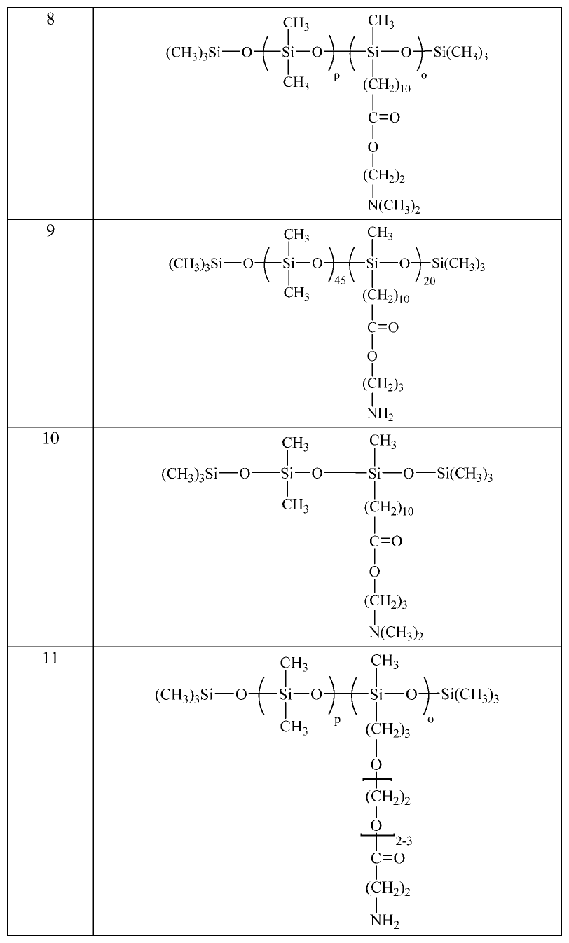

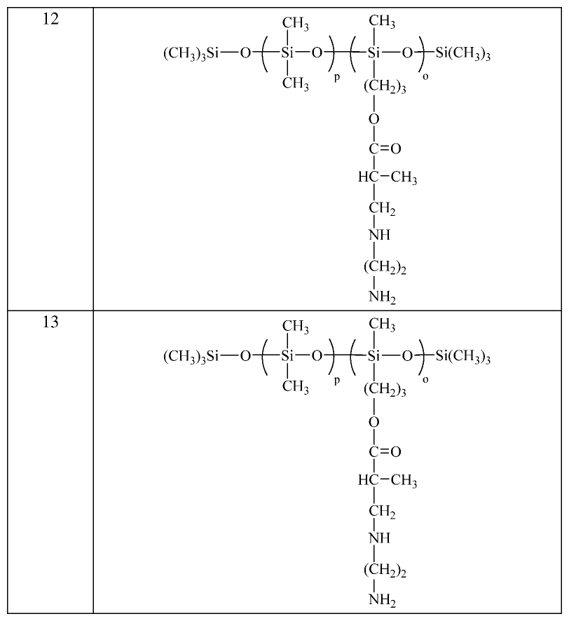

Synthesis Examples 1 through 13 are illustrative examples of making siloxane polymers according to the present disclosure, where the polymers have cleavable bonds in the pendant group. In Synthesis Examples 1-6, the X moiety of the pendant group is a Group I (non-ester) moiety, as described herein. In Synthesis Examples 7-13, the X moiety of the pendant group is a Group II (ester) moiety. FIG. 1 is a table showing the structures of the synthesized siloxane polymers according to the Synthesis Examples below.

### Synthesis Example 1

### A Silyl Ether Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with geraniol (9.21 g; Available from MilliporeSigma, St. Louis, Mo.) and 1% chloroplatinic acid in 2-propanol (60 microliters; Available from MilliporeSigma, St. Louis, Mo.). The mixture is heated with stirring and nitrogen sweep for 16 hours at 80° C.

### Synthesis Example 2

### A Silyl Ether Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with geraniol (6.37 g; Available from MilliporeSigma, St. Louis, Mo.), ethanolamine (6.37 g; Available from MilliporeSigma, St. Louis, Mo.) and 1% chloroplatinic acid in 2-propanol (60 microliters; Available from MilliporeSigma, St. Louis, Mo.). The mixture is heated with stirring and nitrogen sweep for 16 hours at 80° C.

### Synthesis Example 3

### A Silyl Ether Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with ethanolamine (3.43 g; Available from MilliporeSigma, St. Louis, Mo.) and 1% chloroplatinic acid in 2-propanol (60 microliters; Available from MilliporeSigma, St. Louis, Mo.). The mixture is heated with stirring and nitrogen sweep for 16 hours at 80° C.

### Synthesis Example 4

### An Imine Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with 4-Allyloxybenzaldehyde (8.69 g; Available from Sigma-Aldrich, St. Louis, Mo.) and the mixture heated to 70° C. with stirring. Platinum(0)-1,3-divinyl-1,1,3,3-tetramethyldisiloxane complex solution, in xylene, Pt ˜2% (0.14 g; Available from Sigma-Aldrich, St. Louis, Mo.) is added dropwise and the mixture heated for 2.5 hours at 110° C. The mixture is cooled to ambient and ethylenediamine (7.67 g; Available from Sigma-Aldrich, St. Louis, Mo.) is added. The mixture is heated with stirring and nitrogen sweep for 6 hours at 80° C. Excess ethylenediamine is removed via rotary evaporation under reduced pressure to yield a viscous liquid.

### Synthesis Example 5

### An Imine Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with 4-Allyloxybenzaldehyde (8.69 g; Available from Sigma-Aldrich, St. Louis, Mo.) and the mixture heated to 70° C. with stirring. Platinum(0)-1,3-divinyl-1,1,3,3-tetramethyldisiloxane complex solution, in xylene, Pt ˜2% (0.14 g; Available from Sigma-Aldrich, St. Louis, Mo.) is added dropwise and the mixture heated for 2.5 hours at 110° C. The mixture is cooled to ambient and N,N-dimethyl-1,2-diaminoethane (4.50 g; Available from Sigma-Aldrich, St. Louis, Mo.) is added. The mixture is heated with stirring and nitrogen sweep for 6 hours at 80° C. Excess N,N-dimethyl-1,2-diaminoethane is removed via rotary evaporation under reduced pressure to yield a viscous liquid.

### Synthesis Example 6

### An Imine Functionalized Polydimethylsiloxane is Produced as Follows

A MethylHydrosiloxane-Dimethylsiloxane Copolymer, HMS-151 (25.00 g; Viscosity 25-35 cP; 1900-2000 MW; 490 g/mol methylhydrosiloxane functional group MW; Available from Gelest, Inc., Morrisville, Pa.) is combined with 5-Hexen-2-one (5.26 g; Available from Sigma-Aldrich, St. Louis, Mo.) and the mixture heated to 70° C. with stirring. Platinum(0)-1,3-divinyl-1,1,3,3-tetramethyldisiloxane complex solution, in xylene, Pt ˜2% (0.14 g; Available from Sigma-Aldrich, St. Louis, Mo.) is added dropwise and the mixture heated for 2.5 hours at 110° C. The mixture is cooled to ambient and ethylenediamine (7.67 g; Available from Sigma-Aldrich, St. Louis, Mo.) is added. The mixture is heated with stirring and nitrogen sweep for 6 hours at 80° C. Excess ethylenediamine is removed via rotary evaporation under reduced pressure to yield a viscous liquid.

### Synthesis Example 7

### An Ester Functionalized Polydimethylsiloxane is Produced as Follows

A (Carboxydecyl)Methyl-Dimethylsiloxane Copolymer, X-26-1192 (14.00 g; Viscosity 2890 mm²/sec at 25° C.; Available from Shin-Etsu Silicones of America Inc., Akron, Ohio) is combined with ethanolamine (4.38 g; Available from MilliporeSigma, St. Louis, Mo.) and cumene sulfonic acid (16.19 g; Available from Nease, West Chester, Ohio). The mixture is heated with stirring and nitrogen sweep for 16 hours at 150° C.

### Synthesis Example 8

### An Ester Functionalized Polydimethylsiloxane is Produced as Follows

A (Carboxydecyl)Methyl-Dimethylsiloxane Copolymer, X-26-1192 (13.00 g; Viscosity 2890 mm²/sec at 25° C.; Available from Shin-Etsu Silicones of America Inc., Akron, Ohio) is combined with 2-dimethylethanolamine (11.87 g; Available from MilliporeSigma, St. Louis, Mo.). The mixture is heated with stirring and nitrogen sweep for 16 hours at 150° C.

### Synthesis Example 9

### An Ester Functionalized Polydimethylsiloxane is Produced as Follows

A (Carboxydecyl)Methyl-Dimethylsiloxane Copolymer, X-26-1192 (14.00 g; Viscosity 2890 mm²/sec at 25° C.; Available from Shin-Etsu Silicones of America Inc., Akron, Ohio) is combined with 3-amino-1-propanol (5.39 g; Available from MilliporeSigma, St. Louis, Mo.) and cumene sulfonic acid (14.94 g; Available from Nease, West Chester, Ohio). The mixture is heated with stirring and nitrogen sweep for 16 hours at 150° C.

### Synthesis Example 10

### An Ester Functionalized Polydimethylsiloxane is Produced as Follows

A (Carboxydecyl)Methyl-Dimethylsiloxane Copolymer, X-26-1192 (13.00 g; Viscosity 2890 mm²/sec at 25° C.; Available from Shin-Etsu Silicones of America Inc., Akron, Ohio) is combined with 3-(dimethylamino)-1-propanol (13.74 g; Available from MilliporeSigma, St. Louis, Mo.). The mixture is heated with stirring and nitrogen sweep for 16 hours at 150° C.

### Synthesis Example 11

### An Ester Functionalized Polydimethylsiloxane is Produced as Follows

A (Carbinol functional)Methyl-Dimethylsiloxane Copolymer, CMS-222 (14.00 g; Viscosity 150-200 cP; 5,500-6,500 MW; 2000 g/mol hydroxy functional group MW; Available from Gelest, Inc., Morrisville, Pa.) is combined with beta-alanine (1.56 g; Available from MilliporeSigma, St. Louis, Mo.) and cumene sulfonic acid (3.64 g; Available from Nease, West Chester, Ohio). The mixture is heated with stirring and nitrogen sweep for 16 hours at 150° C.

### Synthesis Example 12

### An Amino/Methacryloyloxy Michael Adduct Functionalized Polydimethylsiloxane is Produced as Follows

A (Methacryloyloxypropyl)Methyl-Dimethylsiloxane Copolymer, RMS-083 (10.00 g; 2,000-3,000 cP Viscosity; 769 methacryloxypropyl functional group MW; Available from Gelest, Inc., Morrisville, Pa.) is combined with ethylenediamine (2.48 g; Available from MilliporeSigma, St. Louis, Mo.) and 2-ethyl-1-hexanol (3.12 g; Available from MilliporeSigma, St. Louis, Mo.). The mixture is heated with stirring for 18 hours at 135° C. Excess ethylenediamine is removed via rotary evaporation under reduced pressure to yield a viscous liquid.

### Synthesis Example 13

### An Amino/Methacryloyloxy Michael Adduct Functionalized Polydimethylsiloxane is Produced as Follows

A (Methacryloyloxypropyl)Methyl-Dimethylsiloxane Copolymer, RMS-033 (5.00 g; 1,000-2,000 cP Viscosity; 2584 methacryloxypropyl functional group MW; Available from Gelest, Inc., Morrisville, Pa.) is combined with ethylenediamine (0.47 g; Available from MilliporeSigma, St. Louis, Mo.) and 2-ethyl-1-hexanol (1.37 g; Available from MilliporeSigma, St. Louis, Mo.). The mixture is heated with stirring for 18 hours at 135° C. Excess ethylenediamine is removed via rotary evaporation under reduced pressure to yield a viscous liquid.

### Hydrolysis Example

Hydrolysis Example 1. To show hydrolysis of a siloxane polymer according to the present disclosure, a sample is provided in solution at pH 7 and stored for seven days at 22° C. The solution included 0.1% of an ester-functionalized polydimethylsiloxane polymer according to Synthesis Example 7. The solution further includes 88.9% 2-propanol-d₈, 5.7% deuterium oxide, 5.0% methanol-d₄ and 0.3% aqueous buffer solution to pH 7.0.

At various points over the course of storage, the solution is analyzed with ¹H NMR techniques for the presence of ethanolamine. As ethanolamine is a hydrolysis byproduct of the provided siloxane polymer, the relative percentage of released ethanolamine is directly equivalent to the percentage of total ester bonds hydrolyzed in water. Results are shown in Table 1.

TABLE 1

| Time | Relative % of |
|---|---|
| (days) | ethanolamine released |
| 0 | 0 |
| 3 | 21.0 |
| 7 | 64.3 |

As indicated by the data shown in Table 1, the ester bonds within the pendant of the siloxane polymer are cleaved in the presence of water at pH 7.

### Composition Examples

The following formulations are illustrative consumer product compositions that include siloxane polymers according to the present disclosure. The consumer products may be made according to conventional methods, and may be used in the manner that such types of consumer products are typically used. All ingredient levels are provided as weight percent, by weight of the composition, unless otherwise indicated.

### Composition Example 1

### Liquid Fabric Enhancers

Liquid Fabric Enhancers are prepared by mixing together ingredients shown Table 2.

TABLE 2

| Ingredients | 1A | 1B |
|---|---|---|
| Fabric Softener Active¹ | 8.0 | 7.5 |
| Quaternized polyacrylamide | 0.135 | 0.135 |
| Siloxane polymer from any of | 4.0 | 3.0 |
| Synthesis Examples 1-13 | | |
| Water soluble dialkyl quat | 0.2 | 0.2 |
| Water, emulsifiers, perfume, suds | q.s. to 100% | q.s. to 100% |
| suppressor, stabilizers, preservative, | pH = 3.0 | pH = 3.0 |
| antioxidant, chelant, pH control | | |
| agents, buffers, dyes & other | | |
| optional ingredients | | |

¹Any of the following FSAs: N,N-di(tallowoyloxyethyl)-N,N-dimethylammonium chloride; methyl bis(tallow amidoethyl)2-hydroxyethyl ammonium methyl sulfate; and/or compound of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.

### Composition Example 2

### Liquid Fabric Enhancers

Liquid Fabric Enhancers are prepared by mixing together ingredients shown below in Table 3.

TABLE 3

| Ingredient | 2A | 2B | 2C | 2D | 2E | 2F | 2G | 2H | 2I | 2J |
|---|---|---|---|---|---|---|---|---|---|---|
| FSA^{a} | 14 | 16.47 | 14 | 12 | 12 | 16.5 | — | — | 5 | 5 |
| FSA^{b} | | | | | — | | 3.00 | — | — | — |
| FSA^{c} | | | | | — | | — | 6.5 | — | — |
| Ethanol | 2.18 | 2.57 | 2.18 | 1.95 | 1.95 | 2.57 | — | — | 0.81 | 0.81 |
| Isopropyl | — | — | — | — | — | — | 0.33 | 1.22 | — | — |
| Alcohol | | | | | | | | | | |
| Starch^{d} | 1.25 | 1.47 | 2.00 | 1.25 | — | 2.30 | 0.5 | 0.70 | 0.71 | 0.42 |
| Silicone | 0.6 | 0.75 | 0.6 | 0.75 | 0.37 | 0.60 | 0.37 | 0.6 | 0.37 | 0.37 |
| compound | | | | | | | | | | |
| according to | | | | | | | | | | |
| Synthesis | | | | | | | | | | |
| Examples 1-13 | | | | | | | | | | |
| Phase | 0.21 | 0.25 | 0.21 | 0.21 | 0.14 | — | — | 0.14 | — | — |
| Stabilizing | | | | | | | | | | |
| Polymer^{f} | | | | | | | | | | |
| Calcium | 0.15 | 0.176 | 0.15 | 0.15 | 0.30 | 0.176 | — | 0.1-0.15 | — | — |
| Chloride | | | | | | | | | | |
| DTPA^{h} | 0.017 | 0.017 | 0.017 | 0.017 | 0.007 | 0.007 | 0.20 | — | 0.002 | 0.002 |
| Preservative | 5 | 5 | 5 | 5 | 5 | 5 | — | 250^{j} | 5 | 5 |
| (ppm)^{i, j} | | | | | | | | | | |
| Antifoam^{k} | 0.015 | 0.018 | 0.015 | 0.015 | 0.015 | 0.015 | — | 0.1 | 0.015 | 0.015 |
| Dye | 40 | 40 | 40 | 40 | 40 | 40 | 11 | 30-300 | 30 | 30 |
| (ppm) | | | | | | | | | | |
| Ammonium | 0.100 | 0.118 | 0.100 | 0.100 | 0.115 | 0.115 | — | — | — | — |
| Chloride | | | | | | | | | | |
| HCl | 0.012 | 0.014 | 0.012 | 0.012 | 0.028 | 0.028 | 0.016 | 0.025 | 0.011 | 0.011 |
| Structurant^{l} | 0.01 | 0.01 | 0.01 | 0.01 | 0.01 | 0.01 | 0.01 | 0.01 | 0.01 | 0.01 |
| Perfume | 0.8 | 0.7 | 0.9 | 0.5 | 1.2 | 0.5 | 1.1 | 0.6 | 1.0 | 0.9 |

| | |
|---|---|
| Deionized | To balance |
| Water | |

^{a}N,N-di(tallowoyloxyethyl)-N,N-dimethylammonium chloride.
^{b}Methyl bis(tallow amidoethyl)2-hydroxyethyl ammonium methyl sulfate.
^{c}Compound of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{d}Cationic high amylose maize starch available from National Starch under the trade name CATO ®.
^{f}Copolymer of ethylene oxide and terephthalate having the formula described in U.S. Pat. No. 5,574,179 at col. 15, lines 1-5, wherein each X is methyl, each n is 40, u is 4, each R1 is essentially 1,4-phenylene moieties, each R2 is essentially ethylene, 1,2-propylene moieties, or mixtures thereof.
^{g}SE39 from Wacker
^{h}Diethylenetriaminepentaacetic acid.
ⁱKATHON ® CG available from Rohm and Haas Co. “PPM” is “parts per million.”
^{j}Gluteraldehyde
^{k}Silicone antifoam agent available from Dow Corning Corp. under the trade name DC2310.
^{l}Hydrophobically-modified ethoxylated urethane available from Rohm and Haas under the tradename Aculan 44.

### Composition Example 3

### Dry Laundry Formulations

Dry laundry formulations (e.g., powdered composition) are prepared that include the following ingredients as shown in Table 4.

TABLE 4

| | Wt % in the Formula | | | | | | |
|---|---|---|---|---|---|---|---|
| Ingredient | 3A | 3B | 3C | 3D | 3E | 3F | 3G |
| Brightener | 0.1 | 0.1 | 0.1 | 0.2 | 0.1 | 0.2 | 0.1 |
| Soap | 0.6 | 0.6 | 0.6 | 0.6 | 0.6 | 0.6 | 0.6 |
| Ethylenediamine disuccinic acid | 0.1 | 0.1 | 0.1 | 0.1 | 0.1 | 0.1 | 0.1 |
| Acrylate/maleate copolymer | 1.5 | 1.5 | 1.5 | 1.5 | 1.5 | 1.5 | 1.5 |
| Hydroxyethane di(methylene | 0.4 | 0.4 | 0.4 | 0.4 | 0.4 | 0.4 | 0.4 |
| phosphonic acid) | | | | | | | |
| Mono-C₁₂₋₁₄ alkyl, di-methyl, | 0.5 | 0.5 | 0.5 | 0.5 | 0.5 | 0.5 | 0.5 |
| mono-hydroxyethyl quaternary | | | | | | | |
| ammonium chloride | | | | | | | |
| Linear alkyl benzene | 0.1 | 0.1 | 0.2 | 0.1 | 0.1 | 0.2 | 0.1 |
| Linear alkyl benzene sulphonate | 10.3 | 10.1 | 19.9 | 14.7 | 10.3 | 17 | 10.5 |
| Magnesium sulphate | 0.4 | 0.4 | 0.4 | 0.4 | 0.4 | 0.4 | 0.4 |
| Sodium carbonate | 19.5 | 19.2 | 10.1 | 18.5 | 29.9 | 10.1 | 16.8 |
| Sodium sulphate | 29.6 | 29.8 | 38.8 | 15.1 | 24.4 | 19.7 | 19.1 |
| Sodium Chloride | 0.1 | 0.1 | 0.1 | 0.1 | 0.1 | 0.1 | 0.1 |
| Zeolite | 9.6 | 9.4 | 8.1 | 18 | 10 | 13.2 | 17.3 |
| Photobleach particle | 0.1 | 0.1 | 0.2 | 0.1 | 0.2 | 0.1 | 0.2 |
| Blue and red carbonate speckles | 1.8 | 1.8 | 1.8 | 1.8 | 1.8 | 1.8 | 1.8 |
| Ethoxylated Alcohol AE7 | 1 | 1 | 1 | 1 | 1 | 1 | 1 |
| Tetraacetyl ethylene diamine | 0.9 | 0.9 | 0.9 | 0.9 | 0.9 | 0.9 | 0.9 |
| agglomerate (92 wt % active) | | | | | | | |
| Citric acid | 1.4 | 1.4 | 1.4 | 1.4 | 1.4 | 1.4 | 1.4 |
| PDMS/clay agglomerates (9.5% | 10.5 | 10.3 | 5 | 15 | 5.1 | 7.3 | 10.2 |
| wt % active PDMS) | | | | | | | |
| Polyethylene oxide | 0.2 | 0.2 | 0.2 | 0.2 | 0.2 | 0.2 | 0.2 |
| Enzymes e.g. Protease (84 mg/g | 0.2 | 0.3 | 0.2 | 0.1 | 0.2 | 0.1 | 0.2 |
| active), Amylase (22 mg/g active) | | | | | | | |
| Suds suppressor agglomerate | 0.2 | 0.2 | 0.2 | 0.2 | 0.2 | 0.2 | 0.2 |
| (12.4 wt % active) | | | | | | | |
| Sodium percarbonate (having | 7.2 | 7.1 | 4.9 | 5.4 | 6.9 | 19.3 | 13.1 |
| from 12% to 15% active AvOx) | | | | | | | |
| Perfume oil | 0.5 | 0.5 | 0.5 | 0.5 | 0.5 | 0.5 | 0.5 |
| Solid perfume particles | 0.4 | 0 | 0.4 | 0.4 | 0.4 | 0.4 | 0.6 |
| Silicone compound according to | 1.3 | 2.4 | 1 | 1.3 | 1.3 | 1.3 | 0.7 |
| any of Synthesis Examples 1-13 | | | | | | | |

| | |
|---|---|
| Water and/or minors | Balance |

### Composition Example 4

### Solid Laundry Formulations

Solid laundry formulations (e.g., solid wash beads/pastilles, or powder) are prepared that include the following ingredients as shown in Table 5.

TABLE 5

| Ingredients | 4A | 4B | 4C | 4D |
|---|---|---|---|---|
| Polyethylene | 7 0-99 | 0-20 | 0-29 | 0-40 |
| glycol¹ | | | | |
| Bentonite | 0-29 | 0-20 | 0-20 | 0-10 |
| Clay | | | | |
| NaCl | 0-29 | 50-99 | 0-29 | 0-40 |
| Na2SO4 | 0-10 | 0-10 | 0-10 | 0-5 |
| Zeolite | 0-29 | 0-29 | 0-29 | 0-5 |
| Starch/ | 0-29 | 0-29 | 0-29 | 0-5 |
| Zeolite | | | | |
| Silica | 0-5 | 0-5 | 0-5 | 0-5 |
| Perfume | 0-5 | 0-5 | 0-5 | 0-5 |
| Silicone | 0.001-10 | 0.001-4.5 | 0.001-3 | 0.001-7.5 |
| compound | | | | |
| according | | | | |
| to any of | | | | |
| Synthesis | | | | |
| Examples | | | | |
| 1-13 | | | | |
| Plasticizers/ | Balance | | | |
| solvents/ | | | | |
| water | | | | |
| Form | Semi- | Free flowing | Semi-spherical | Free flowing |
| | spherical | powder | bead | powder |
| | bead | | | |

¹Polyethylene glycol having a molecular weight from 5,000 to 11,000 Da

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A siloxane polymer comprising one or more repeat units having the structure of Formula (I):
wherein: 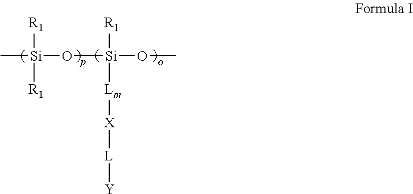
a) each L is a linking bivalent alkylene radical, preferably each L is independently selected from the group consisting of 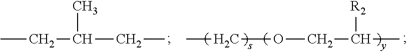
—(CH₂)ₛ—; —(H₂C)ₛOC₆H₄— and combinations thereof, more preferably at least one L is —(CH₂)ₛ— or —(H₂C)ₛOC₆H₄—, even more preferably at least one L is —(CH₂)ₛ—,
wherein
each R₂ is independently selected from the group consisting of H, C₁-C₄ alkyl, substituted alkyl, aryl, substituted aryl, and combinations thereof; preferably H or C₁-C₄ alkyl, most preferably H or methyl,
each s is independently an integer of from 1 to about 20, preferably each s is independently an integer of from 2 to about 12;
each y is independently an integer of from 1 to about 100, preferably each y is independently an integer of from 1 to about 20, more preferably y is independently an integer of from 1 to about 10;
b) each X is independently selected from the group consisting of
(i) a Group I (non-ester) moiety selected from the group consisting of: 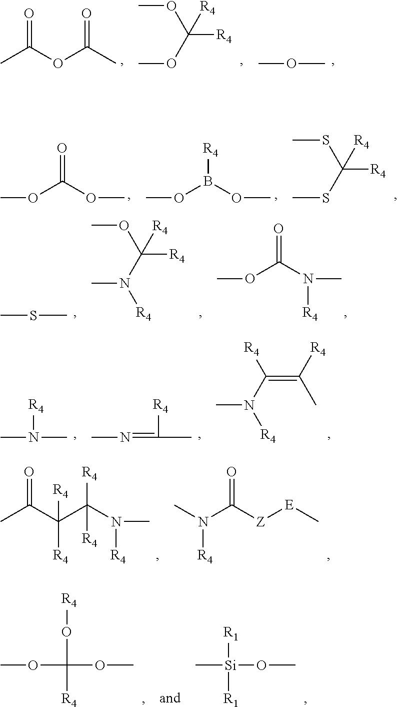
wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; wherein Z is defined as below;
preferably each X is independently selected from the group consisting of 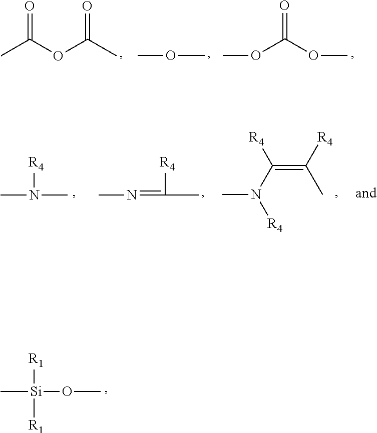
more preferably each X is independently selected from the group consisting of 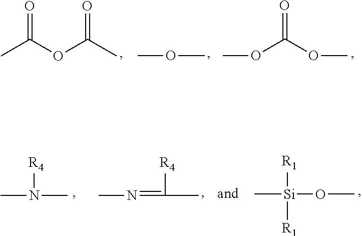
wherein each index m is one or zero with the proviso that when X is oxygen, the index m is 0; and/or
(ii) a Group II (ester) moiety selected from the group consisting of: 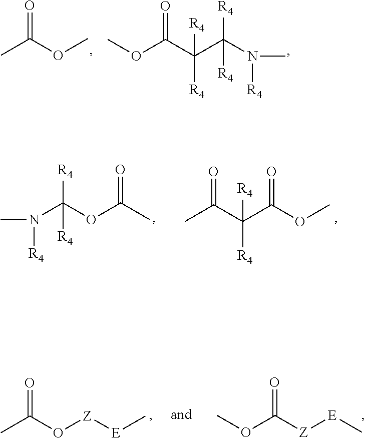
wherein E is an electron-withdrawing group, preferably E is selected from the group consisting of N, O, S, an aryl moiety, and an alkene moiety, more preferably E is N;
each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl; and
each Z is independently selected from the group consisting of C₁-C₃₂ alkylene, C₁-C₃₂ substituted alkylene, C₆-C₃₂ aryl, C₅-C₃₂ substituted aryl, C₆-C₃₂ alkylenearyl, and C₅-C₃₂ substituted alkylenearyl, preferably Z is C₁-C₃₂ alkylene or C₁-C₃₂ substituted alkylene, most preferably Z is selected from C₁-C₄ alkylene or C₁-C₄ substituted alkylene or each Z is independently selected from the group consisting of: 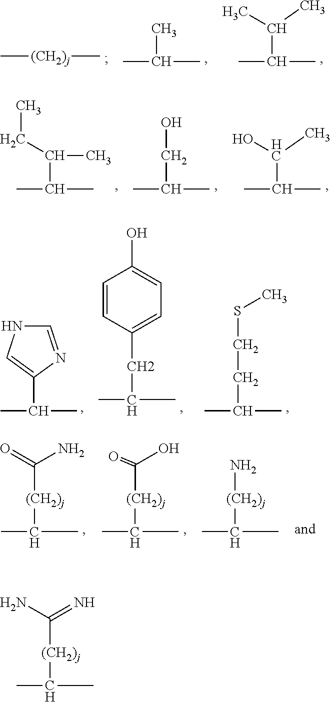
the index j is an integer from 1-32, preferably j is an integer form 1-10, more preferably j is an integer from 2 to 8, most preferably j in an integer from 2 to 4,
wherein each index m is one;
c) each R₁ is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl, C₁-C₃₂ alkoxy and C₁-C₃₂ substituted alkoxy; preferably each R₁ is independently selected from the group consisting of H, OH, C₁-C₁₆ alkyl, C₁-C₄ alkoxy, a benzyl moiety and a phenylpropyl moiety, more preferably each R₁ is independently selected from the group consisting of H, OH, C₁ alkyl and C₁ alkoxy;
d) each Y is independently selected from the group consisting of H, OH, C₁-C₃₂ alkyl, C₁-C₃₂ substituted alkyl, C₆-C₃₂ aryl, C₅-C₃₂ substituted aryl, C₆-C₃₂ alkylaryl and C₆-C₃₂ substituted alkylaryl, preferably Y contains an amino moiety, a hydroxy moiety, a thiol moiety, a carboxy moiety and a quaternary ammonium moiety, more preferably Y contains an amino moiety or a quaternary ammonium moiety;
e) index p is an integer of from about 2 to about 1000, preferably p is an integer from about 10 to about 500, more preferably p is an integer from about 20 to about 200; and
f) index o is an integer of from about 1 to about 500, preferably o is an integer from about 1 to about 50, more preferably o is an integer from about 1 to about 20.

2. A siloxane polymer according to claim 1 having the following structure:
wherein: 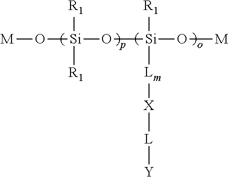
each L is a linking bivalent alkylene radical, preferably L is selected from —(CH₂)ₛ— and 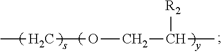
more preferably L is —(CH₂)ₛ—,
each s is independently an integer of from 1 to about 20, preferably each s is independently an integer of from 2 to about 12;
each X is independently selected from the group consisting of:
(i) a Group I (non-ester) moiety: 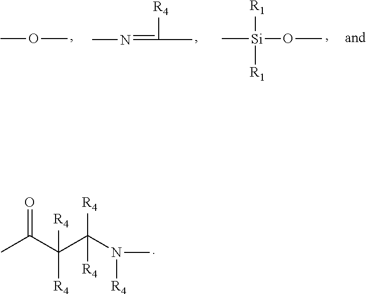
wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl,
wherein each index m is one or zero with the proviso that when X is oxygen, the index m is 0; and/or
(ii) a Group II (ester) moiety: 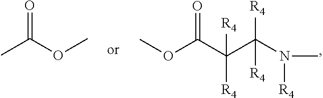
wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl,
wherein each index m is one;
each R₁ is methyl;
each Y is independently selected from the group consisting of C₁-C₃₂ substituted alkyl, C₅-C₃₂ substituted aryl, C₆-C₃₂ substituted alkylaryl, wherein the substitution, if any, is an amino moiety or quaternary ammonium moiety;
index p is an integer of from about 10 to about 500;
index o is an integer of from about 1 to about 20; and
each M is 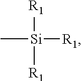
wherein each R₁ is independently selected from the group as is described above.

3. A siloxane polymer according to claim 1, wherein each X is independently selected from the group consisting of:
(i) a Group I (non-ester) moiety: 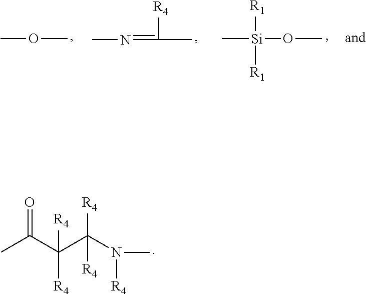
wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl.

4. A siloxane polymer according to claim 1, wherein each X is independently selected from a Group II (ester) moiety: 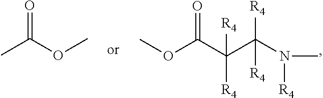
wherein each R₄ moiety is independently selected from the group consisting of H, C₁-C₃₂ alkyl, C₁-C₃₂ substituted alkyl, C₆-C₃₂ aryl, C₅-C₃₂ substituted aryl, C₆-C₃₂ alkylaryl, C₆-C₃₂ substituted alkylaryl.

5. A siloxane polymer according to claim 1, wherein each X is

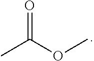

6. A siloxane polymer according to claim 1, wherein the Y group comprises an amino moiety or quaternary ammonium moiety.

7. A composition comprising a siloxane polymer according to claim 1, and a carrier.

8. A composition according to claim 7, wherein said composition comprises from about 0.2% to about 10%, preferably from about 0.5% to about 5%, by weight of said composition, of said siloxane polymer.

9. A composition according to claim 7, wherein said composition further comprises a surfactant, preferably wherein said surfactant is selected from the group consisting of an anionic surfactant, a nonionic surfactant, a cationic surfactant, an amphoteric surfactant, and mixtures thereof, more preferably said surfactant is selected from the group consisting of a linear or branched alkyl benzene sulfonate, an alkyl sulfate, an alkyl ethoxy sulfate, an alkyl ethoxylate, an alkyl glyceryl sulfonate, a quaternary ammonium surfactant, and mixtures thereof, preferably wherein said quaternary ammonium surfactant is an ester quaternary ammonium compound.

10. A composition according to claim 7, said composition further comprising an adjunct ingredient selected from the group consisting of surfactants, color care polymers, deposition aids, surfactant boosting polymers, pH adjusters, product color stabilizers, preservatives, solvents, builders, chelating agents, dye transfer inhibiting agents, dispersants, enzymes, and enzyme stabilizers, catalytic materials, bleach, bleach activators, polymeric dispersing agents, clay soil removal/anti-redeposition agents, brighteners, suds suppressors, dyes, UV absorbers, perfume, an additional perfume delivery system, structure elasticizing agents, thickeners/structurants, fabric softeners, carriers, hydrotropes, oligoamines, processing aids, hueing agents, pigments and mixtures thereof.

11. A composition according to claim 7, wherein the composition comprises a deposition aid, preferably said deposition aid comprises a cationic polymer, preferably said cationic polymer is a cationic polymer having a net cationic charge density of from about 0.2 meq/g to about 20 meq/g.

12. A composition according to claim 7, said composition having a pH of from about 2 to about 4, preferably a pH of from about 2 to about 3.7, more preferably a pH from about 2 to about 3.5.

13. A composition according to claim 7, wherein said composition further comprises an ester quaternary ammonium compound, more preferably said composition comprises, based on total composition weight, from about 3% to about 25%, preferably from about 4% to about 20%, more preferably from about 5% to about 15%, most preferably from about 7% to about 12% of said ester quaternary ammonium compound.

14. A composition according to claim 7, wherein said composition is in solid form, liquid form, or a mixture thereof, preferably in liquid form.

15. A composition according to claim 7, wherein said composition is a fabric care composition.

16. A composition according to claim 7, wherein said composition comprises neat perfume, encapsulated perfume, or a mixture thereof.

17. A composition according to claim 7, wherein said carrier comprises water, a non-aqueous solvent, a salt, or a combination thereof.

18. A composition according to claim 7, wherein the siloxane polymer is a polymer according to any of Synthesis Examples 1-13, preferably according to any of Synthesis Examples 7-13.

19. A method of treating a surface, said method comprising the step of contacting a surface, preferably a fabric, with a composition according to claim 7.

20. A method of treating a surface according to claim 19, wherein the composition is diluted by the water to form a treatment liquor,
wherein the composition has a pH that is less than the pH of the treatment liquor.
